(19) United States
(12) Patent Application Publication
(10) Pub. No.: US 2008/0035726 A1
(43) Pub. Date: Feb. 14, 2008

(54) Portable terminal

(75) Inventor: Kenji Yamada, Hino-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/633,388

(22) Filed: Dec. 1, 2006

(30) Foreign Application Priority Data
Aug. 10, 2006 (JP) 2006-218487

(51) Int. Cl. G06K 5/00; G06F 17/00

(52) U.S. Cl. 235/382; 235/375

(57) ABSTRACT

A portable terminal includes a disk unit configured to store data, a communication unit configured to perform short-distance radio frequency identification with an external reader/writer, and a control unit configured to stop the operation of the disk unit in accordance with a radio wave transmitted from the reader/writer and detected by the communication unit.

### CROSS-REFERENCE TO RELATED APPLICATIONS

This application is based upon and claims the benefit of priority from prior Japanese Patent Application No. 2006-218487, filed Aug. 10, 2006, the entire contents of which are incorporated herein by reference.

### BACKGROUND OF THE INVENTION

1. Field of the Invention

The present invention relates to a portable terminal including a radio frequency identification function and an HDD.

2. Description of the Related Art

A portable terminal having a radio frequency identification (RFID) function is known. The radio frequency identification function installed in the portable terminal is known as, e.g., “Mobile FeliCa®”. Similar to a noncontact IC card technique, such portable terminal can be used as e-money, an employee's ID card, a member's card, a ticket, an apartment key, and the like when a user brings it above a reader/writer.

Various content broadcasting services are provided for such portable terminal. A flash memory mounted in the portable terminal stores downloaded contents. A hard disk drive (HDD) can store a larger amount of data at lower cost than the flash memory. Recently, the HDD has been downsized, and a portable terminal with the HDD to store many contents has emerged.

When an impact acts on the HDD while the HDD is in non-operation, it does not damage the hard disk so often because a read/write head is retracted to a position beside the hard disk. However, when an impact acts on the HDD while the HDD is in operation, it often damages the hard disk because the read/write head is located close to the hard disk with only a small gap between them.

The radio communicable distance between the portable terminal and the reader/writer is short. Hence, when a user brings the portable terminal close to the reader/writer in order to perform radio communication, the portable terminal often comes into contact with the reader/writer. If the portable terminal comes into contact with the reader/writer in the operation time of the HDD mounted in the portable terminal, the impact may damage the HDD upon contact.

### BRIEF SUMMARY OF THE INVENTION

According to the present invention, a portable terminal comprises a disk unit configured to store data, a communication unit configured to perform short-distance radio frequency identification with an external reader/writer, and a control unit configured to stop an operation of the disk unit in accordance with a radio wave transmitted from the reader/writer and detected by the communication unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of a cellular phone as a portable terminal according to an embodiment of the present invention;

FIGS. 2A, 2B, 2C, and 2D are views showing the portable terminal and a reader/writer in a time-serial manner, when performing short-distance radio frequency identification;

FIG. 3 is a flowchart showing the control sequence of a control unit when performing short-distance radio frequency identification; and

FIG. 4 is a flowchart showing the control sequence of the control unit, concerning content playback processing.

### DETAILED DESCRIPTION OF THE INVENTION

An embodiment of the present invention will be described below with reference to the accompanying drawing.

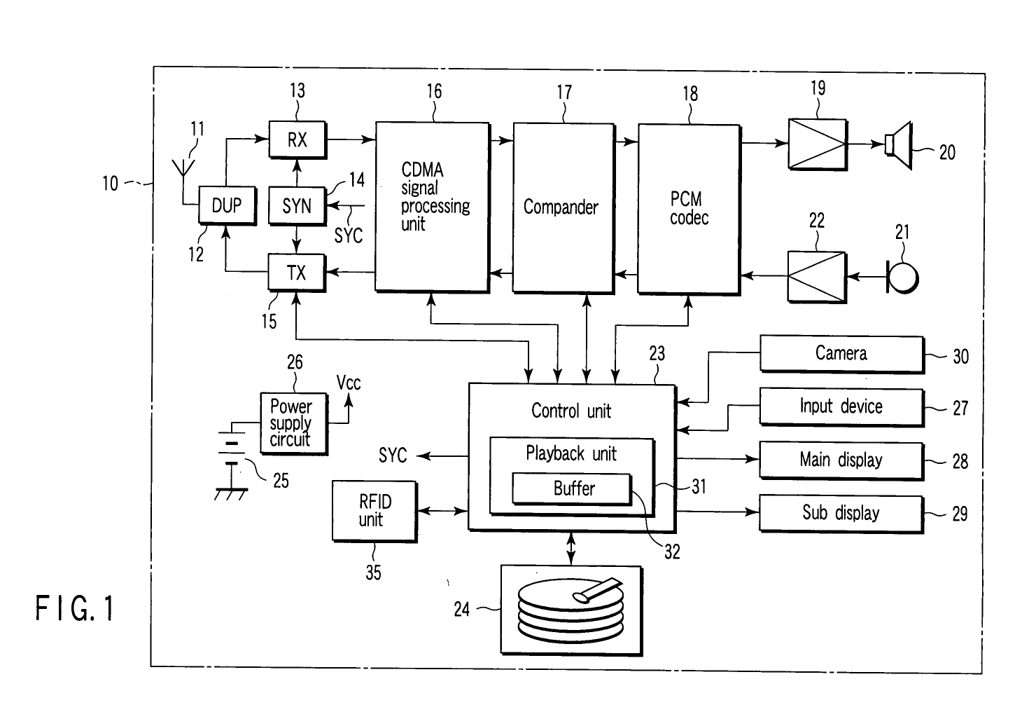

FIG. 1 is a block diagram showing the arrangement of a cellular phone as a portable terminal according to an embodiment of the present invention.

A radio signal transmitted from a base station (not shown) is received by an antenna 11, and is input to a reception circuit (RX) 13 via an antenna duplexer (DUP) 12. The reception circuit 13 frequency-converts (down-converts) the received radio signal to an intermediate-frequency signal by mixing it with a local oscillation signal output from a frequency synthesizer (SYN) 14. The reception circuit 13 then quadrature-demodulates this down-converted intermediate-frequency signal to output a received baseband signal. Note that the frequency of the local oscillation signal generated by the frequency synthesizer 14 is designated by a control signal SYC from a control unit 23.

The received baseband signal is input to a CDMA signal processing unit 16. The CDMA signal processing unit 16 comprises a RAKE receiver. The RAKE receiver despreads paths included in the received baseband signal by spread codes. The despread path signals are mixed after their phases are arbitrated. As a result, reception packet data of a predetermined transmission format is obtained. The reception packet data is input to a compander 17.

In speech communication, the compander 17 decodes, by a speech codec, speech data contained in the reception packet data output from the CDMA signal processing unit 16. A digital audio signal obtained by this decoding process is output to a PCM codec 18. The PCM codec 18 PCM-decodes this digital audio signal and outputs an analog speech signal. This analog speech signal is amplified by an incoming speech amplifier 19, and is then output from a loudspeaker 20.

Upon receiving email or downloading contents, the compander 17 sends, to the control unit 23, email data or content data contained in the reception packet data. The control unit 23 stores the email data or content data sent from the compander 17, in a disk unit such as an HDD unit 24.

Upon reception of an email display request through an input device 27, the control unit 23 reads out corresponding email data from the HDD unit 24, and displays it on a main display 28.

Upon reception of a content playback request through the input device 27, the control unit 23 reads out corresponding content data from the HDD unit 24. To cope with such processing, the control unit 23 includes a playback unit 31 configured to play back contents stored in the HDD unit 24. The playback unit 31 includes a buffer 32 configured to temporarily store data read out from the HDD unit 24.

When the content data is audio content data, the control unit 23 outputs the audio data to the compander 17. The audio data is decoded by the compander 17, and then converted into an analog signal by the PCM codec 18. After that, the converted audio data is amplified by the incoming speech amplifier 19, and output from the loudspeaker 20.

On the other hand, when the content data is video content data, the control unit 23 decodes the video data by an internal video codec, and displays it on the main display 28.

In speech communication, a speech signal of a speaker input to a microphone 21 is amplified to an appropriate level by an outgoing speech amplifier 22. The amplified speech signal undergoes a PCM coding process by the PCM codec 18 to be converted into a digital audio signal, which is input to the compander 17. Also, a video signal output from a camera 30 is converted into a digital signal by the control unit 23, and is input to the compander 17.

The compander 17 detects the amount of energy of input speech from the digital audio signal output from the PCM codec 18, and determines a transmission data rate based on this detection result. The compander 17 encodes the digital audio signal to a signal of a format according to the transmission data rate, thereby generating audio data. Also, the compander 17 encodes the digital video signal output from the control unit 23 to generate video data. The compander 17 packetizes these audio and video data according to a predetermined transmission format using a multiplexer/demultiplexer, and outputs this transmission packet data to the CDMA signal processing unit 16. When text data such as an email message or the like is output from the control unit 23, it is also multiplexed on the transmission packet data.

Note that the video data generated by the compander 17 is displayed on the main display 28 under the control of the control unit 23.

The CDMA signal processing unit 16 applies a spread spectrum process to the transmission packet data output from the compander 17 using spread codes assigned to a transmission channel. Then, the CDMA signal processing unit 16 outputs that output signal to a transmission circuit (TX) 15. The transmission circuit 15 modulates the spread spectrum signal using a digital modulation scheme such as a QPSK (Quadrature Phase Shift Keying) scheme or a QAM (Quadrature Amplitude Modulation) scheme. The transmission circuit 15 frequency-converts the transmission signal generated by this modulation process into a radio signal by mixing it with a local oscillation signal generated by the frequency synthesizer 14. The transmission circuit 15 then high-frequency-amplifies the radio signal to a transmission power level designated by the control unit 23. The amplified radio signal is supplied to the antenna 11 via the antenna duplexer 12, and is transmitted from the antenna 11 to the base station.

A sub display 29 displays information representing the operation mode of a cellular phone 10, incoming call notification information, and information representing the remaining capacity and charged state of a battery 25. A power supply circuit 26 generates a predetermined operation power supply voltage Vcc based on the output from the battery 25, and then supplies it to each circuit. A charging circuit (not shown) charges the battery 25.

The cellular phone 10 includes a communication unit such as an RFID unit 35 configured to perform short-distance radio communication with the external reader/writer. The RFID unit 35 includes, e.g., a coil serving as an antenna that detects a radio wave transmitted from the reader/writer, a nonvolatile memory such as a flash memory that holds data, and an IC that communicates with the reader/writer and performs processing.

The RFID unit 35, which comprises, e.g., a “Mobile FeliCa®” IC chip, can be used in various scenes only when the user brings the cellular phone 10 above the reader/writer. For example, the RFID unit 35 can be used for personal authentication, e-money settlement, and value charging. Additionally, the main display 28 can display data such as an outstanding balance and a usage history held in the memory in the RFID unit 35.

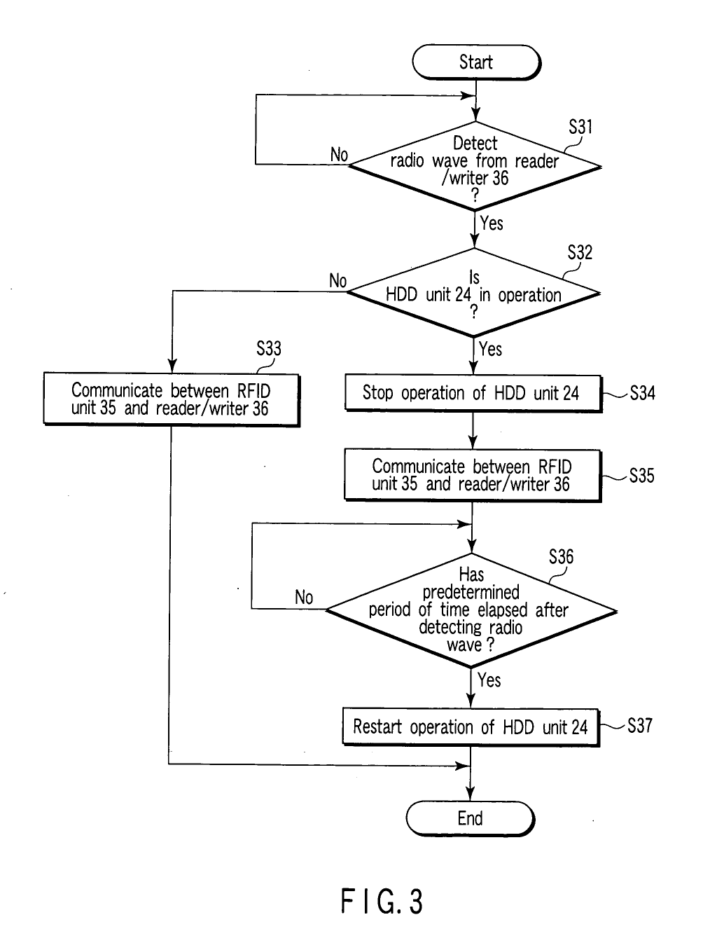

FIG. 3 is a flowchart showing the control sequence of the control unit 23 when performing short-distance radio frequency identification.

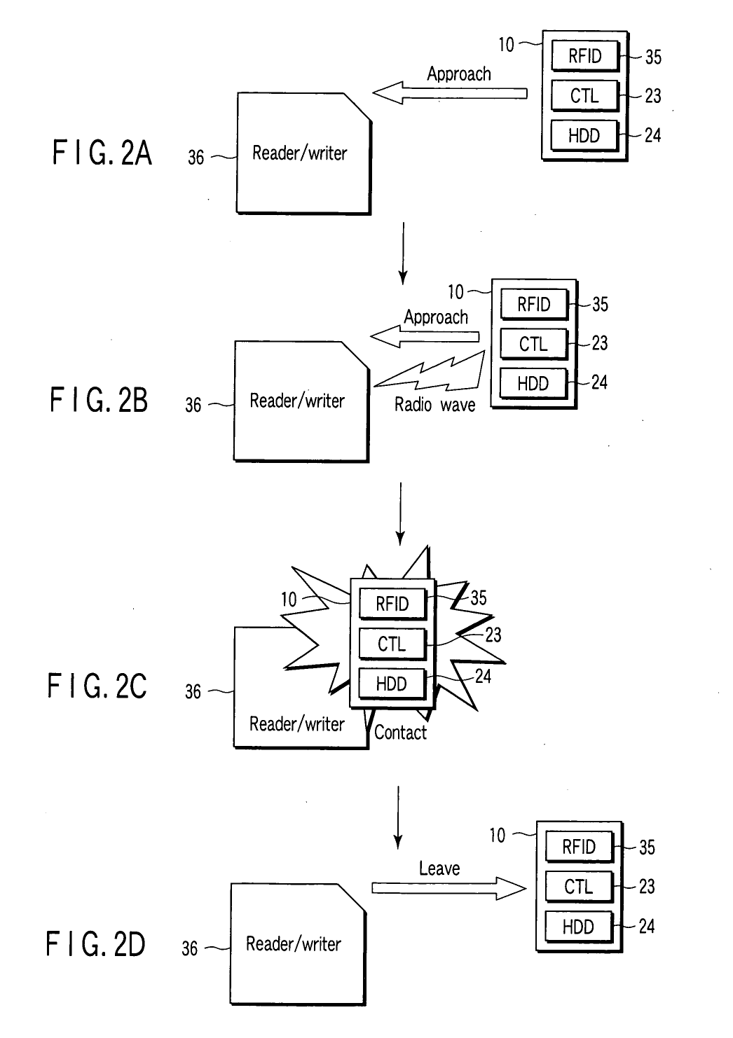

First, the control unit 23 determines whether the RFID unit 35 detects a radio wave transmitted from a reader/writer 36 (step S31). If NO in step S31, the control unit 23 stands by. In this state, the cellular phone 10 is located at a distance by which the cellular phone 10 cannot communicate with the reader/writer 36 (FIG. 2A).

If YES in step S31, the control unit 23 determines whether the HDD unit 24 is in operation (step S32). In this state, the cellular phone 10 is approached within a distance by which the cellular phone 10 can communicate with the reader/writer 36 (FIG. 2B). After that, the cellular phone 10 is often brought into contact with the reader/writer 36 (FIG. 2C). The cellular phone 10 is then brought away from the reader/writer 36 (FIG. 2D).

If NO in step S32, the RFID unit 35 communicates with the reader/writer 36 to perform radio frequency identification (step S33). After the communication ends, a series of operations end.

On the other hand, if YES in step S32, the control unit 23 stops the operation of the HDD unit 24 (step S34). Subsequently, the RFID unit 35 communicates with the reader/writer 36 to perform radio frequency identification (step S35). After the communication ends, the control unit 23 determines whether a predetermined period of time has elapsed after the radio wave is detected (step S36). The control unit 23 stands by until the predetermined period of time elapses. When the predetermined period of time has elapsed, the control unit 23 restarts the operation of the HDD unit 24 (step S37), and a series of operations end.

In this case, the control unit 23 restarts the operation of the HDD unit 24 a predetermined period of time after the RFID unit 35 detects the radio wave. However, a timing for restarting the operation of the HDD unit 24 is not limited to this. The operation of the HDD unit 24 may be restarted at another timing. For example, the operation of the HDD unit 24 may be restarted a predetermined period of time after the operation of the HDD unit 24 is stopped. As another example, the operation of the HDD unit 24 may be restarted a predetermined period of time after the RFID unit 35 starts communicating with the reader/writer 36. As still another example, the operation of the HDD unit 24 may be restarted after the RFID unit 35 fails to detect the radio wave transmitted from the reader/writer 36. As still another example, the operation of the HDD unit 24 may be restarted a predetermined period of time after the RFID unit 35 fails to detect the ratio wave transmitted from the reader/writer 36.

In the above control, when the HDD unit 24 has already been operated for, e.g., playing back contents in the above control processing, the operation of the HDD unit 24 is restarted after performing radio frequency identification. However, content playback processing or the like may be finished in accordance with a stop of the operation of the HDD unit 24.

The communicable distance of “mobile FeliCa®” is about 10 cm, and a time required for transaction processing is generally about 100 ms. Accordingly, the time from when the RFID unit 35 detects the radio wave until the cellular phone 10 is brought into contact with the reader/writer 36 may be shorter than 1 sec. Hence, it can be said that the control unit has only to stop the operation of the HDD unit for, e.g., 2 seconds.

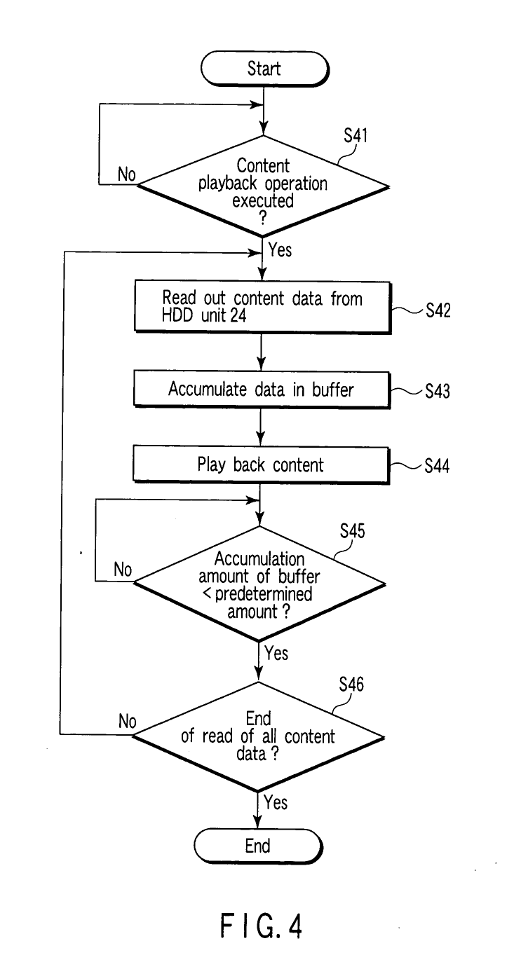

FIG. 4 is a flowchart showing the control sequence of the control unit 23, concerning content playback processing.

First, the control unit 23 determines whether a content playback operation is executed (step S41). If NO in the step S41, the control unit 23 stands by.

If YES in step S41, the control unit 23 intermittently reads out playback target content data from the HDD unit 24 dividing the playback target content data among a plurality of number of times (step S42), temporarily accumulates one-time readout data in the buffer 32 (step S43), and then plays back data accumulated in the buffer 32 (step S44).

During playback of contents, the control unit 23 determines whether a data accumulation amount in the buffer 32 is smaller than a predetermined value (step S45). The predetermined value as a determination criterion of an accumulation amount may be a preset amount or an amount of data to be played back while the HDD unit 24 remains stopped. If NO in step S45, the control unit 23 stands by, and continues to play back the contents.

If YES in step S45, the control unit 23 determines whether all the playback target content data has been read out (step S46). If NO in step S46, the process returns to step S42 to read out the next content data. After that, processes in steps S43 to S46 are repeated. If YES in step S46, the control unit 23 plays back remaining content data in the buffer 32, and then finishes the content playback operation.

In the above operation, when data accumulated in the buffer 32 is in short supply while the operation of the HDD unit 24 is maintained stopped, the control unit 23 reads out data of a predetermined alarm sound from a memory (in the main body) different from the HDD unit 24 to generate the alarm sound until the operation of the HDD unit 24 is restarted.

As described above, according to this embodiment, the operation of the HDD unit 24 is stopped in expectation of contact with the reader/writer 36. Accordingly, the HDD unit 24 can be prevented from being damaged by the impact upon contact. Accordingly, a dedicated sensor need not be added in order to predict contact with the reader/writer 36.

The embodiment of the present invention has been described herein with reference to the accompanying drawings. However, the present invention is not limited to such embodiment, and various changes and modifications may be effected therein without departing from the spirit or scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable terminal comprising:
a disk unit configured to store data;
a communication unit configured to perform short-distance radio frequency identification with an external reader/writer; and
a control unit configured to stop an operation of the disk unit in accordance with a radio wave transmitted from the reader/writer and detected by the communication unit.

2. A terminal according to claim 1, wherein the control unit restarts the operation of the disk unit a predetermined period of time after the communication unit detects the radio wave transmitted from the reader/writer.

3. A terminal according to claim 1, wherein the control unit restarts the operation of the disk unit a predetermined period of time after the control unit restarts stops the operation of the disk unit.

4. A terminal according to claim 1, wherein the control unit restarts the operation of the disk unit a predetermined period of time after a start of communication between the communication unit and the reader/writer.

5. A terminal according to claim 1, wherein the control unit restarts the operation of the disk unit after the communication unit fails to detect the radio wave transmitted from the reader/writer.

6. A terminal according to claim 1, wherein the control unit restarts the operation of the disk unit a predetermined period of time after the communication unit fails to detect the radio wave transmitted from the reader/writer.

7. A terminal according to claim 2, wherein the control unit includes a playback unit configured to play back contents stored in the disk unit, and
the playback unit includes a buffer configured to temporarily store data read out from the disk unit, configured to intermittently read out playback target content data from the disk unit dividing the playback target content data among a plurality of number of times, configured to accumulate one-time readout data in the buffer, and configured to read out remaining data from the disk unit again if a data amount in the buffer is smaller than a predetermined amount upon playback of the contents, so as to ensure storing, in the buffer, at least data to be played back while the operation of the disk unit is maintained stopped.

8. A terminal according to claim 3, wherein the control unit includes a playback unit configured to play back contents stored in the disk unit, and
the playback unit includes a buffer configured to temporarily store data read out from the disk unit, configured to intermittently read out playback target content data from the disk unit dividing the playback target content data among a plurality of number of times, configured to accumulate one-time readout data in the buffer, and configured to read out remaining data from the disk unit again if a data amount in the buffer is smaller than a predetermined amount upon playback of the contents, so as to ensure storing, in the buffer, at least data to be played back while the operation of the disk unit is maintained stopped.

9. A terminal according to claim 4, wherein the control unit includes a playback unit configured to play back contents stored in the disk unit, and
the playback unit includes a buffer configured to temporarily store data read out from the disk unit, configured to intermittently read out playback target content data from the disk unit dividing the playback target content data among a plurality of number of times, configured to accumulate one-time readout data in the buffer, and configured to read out remaining data from the disk unit again if a data amount in the buffer is smaller than a predetermined amount upon playback of the contents, so as to ensure storing, in the buffer, at least data to be played back while the operation of the disk unit is maintained stopped.

10. A terminal according to claim 5, wherein the control unit includes a playback unit configured to play back contents stored in the disk unit, and
the playback unit includes a buffer configured to temporarily store data read out from the disk unit, configured to intermittently read out playback target content data from the disk unit dividing the playback target content data among a plurality of number of times, configured to accumulate one-time readout data in the buffer, and configured to read out remaining data from the disk unit again if a data amount in the buffer is smaller than a predetermined amount upon playback of the contents, so as to ensure storing, in the buffer, at least data to be played back while the operation of the disk unit is maintained stopped.

11. A terminal according to claim 6, wherein the control unit includes a playback unit configured to play back contents stored in the disk unit, and
the playback unit includes a buffer configured to temporarily store data read out from the disk unit, configured to intermittently read out playback target content data from the disk unit dividing the playback target content data among a plurality of number of times, configured to accumulate one-time readout data in the buffer, and configured to read out remaining data from the disk unit again if a data amount in the buffer is smaller than a predetermined amount upon playback of the contents, so as to ensure storing, in the buffer, at least data to be played back while the operation of the disk unit is maintained stopped.

12. A portable terminal comprising:
a disk configured to store data;
a communication unit configured to perform short-distance radio frequency identification with an external reader/writer; and
a control unit configured to stop an operation of the disk at the interchange with the reader/writer, and restarts the operation of the disk a predetermined period of time after the communication unit detects the radio wave transmitted from the reader/writer.

13. A terminal according to claim 2, further comprising a buffer configured to store data read out from the disk, wherein if the data accumulated in the buffer is in short supply while the operation of the disk is maintained stopped, the control unit reads out the data of a predetermined alarm sound from a memory different from the disk to generate the alarm sound until the operation of the disk is restarted.

14. A terminal according to claim 3, further comprising a buffer configured to store data read out from the disk, wherein if the data accumulated in the buffer is in short supply while the operation of the disk is maintained stopped, the control unit reads out the data of a predetermined alarm sound from a memory different from the disk to generate the alarm sound until the operation of the disk is restarted.

15. A terminal according to claim 4, further comprising a buffer configured to store data read out from the disk, wherein if the data accumulated in the buffer is in short supply while the operation of the disk is maintained stopped, the control unit reads out the data of a predetermined alarm sound from a memory different from the disk to generate the alarm sound until the operation of the disk is restarted.

16. A terminal according to claim 5, further comprising a buffer configured to store data read out from the disk, wherein if the data accumulated in the buffer is in short supply while the operation of the disk is maintained stopped, the control unit reads out the data of a predetermined alarm sound from a memory different from the disk to generate the alarm sound until the operation of the disk is restarted.

17. A terminal according to claim 6, further comprising a buffer configured to store data read out from the disk, wherein if the data accumulated in the buffer is in short supply while the operation of the disk is maintained stopped, the control unit reads out the data of a predetermined alarm sound from a memory different from the disk to generate the alarm sound until the operation of the disk is restarted.
